(19) United States
(12) Patent Application Publication
(10) Pub. No.: US 2015/0181615 A1
(43) Pub. Date: Jun. 25, 2015

(54) SYSTEMS AND METHODS FOR CAPACITY MANAGEMENT FOR A DISTRIBUTED ANTENNA SYSTEM

(71) Applicant: ADC Telecommunications, Inc., Berwyn, PA (US)

(72) Inventors: Boris Golubovic, San Francisco, CA (US); Lance K. Uyehara, San Jose, CA (US); Paul Schatz, Burnsville, MN (US)

(21) Appl. No.: 14/557,771

(22) Filed: Dec. 2, 2014

Related U.S. Application Data
(60) Provisional application No. 61/920,342, filed on Dec. 23, 2013.

(51) Int. Cl. H04W 72/08; H04W 72/04

(52) U.S. Cl. CPC H04W 72/085; H04W 72/0453; H04W 72/0486; H04W 72/0446; H04W 88/085

(57) ABSTRACT

Systems and methods for capacity management for a distributed antenna system are provided. In one embodiment, a distributed antenna system comprises: a host unit; a plurality of remote antenna units coupled to the host unit via a plurality of communication links, wherein the plurality of communication links transport a radio frequency (RF) carrier signal between the host unit and at least one wireless subscriber unit via the plurality of remote units; and at least one capacity processor, wherein the capacity processor alters at least a portion of the RF carrier signal such that the at least one wireless subscriber unit can utilize a bandwidth of the RF carrier signal that is less than a full available bandwidth of the RF carrier signal.

### CROSS-REFERENCE TO RELATED APPLICATIONS

This application claims priority to, and the benefit of, U.S. Provisional Application No. 61/920,342 entitled “SYSTEMS AND METHODS FOR CAPACITY MANAGEMENT FOR A DISTRIBUTED ANTENNA SYSTEM” which was filed on Dec. 23, 2013 and which is herein incorporated by reference in its entirety.

### BACKGROUND

Current Distributed Antenna Systems (DAS) typically simulcast signals from a cellular base station, or similar RF source, to multiple antenna locations that are physically separated from each other to provide better, more uniform cellular coverage. The offered capacity of the base station is therefore uniformly spread over each of the antenna points. In some scenarios it may be preferred to have more capacity allocated to a specific antenna location or a few of the antenna locations in the collection of remote antennas. This would allow the operator to prioritize capacity to where it is needed most or to where someone is willing to pay a premium for a larger share of the offered capacity.

For the reasons stated above and for other reasons stated below which will become apparent to those skilled in the art upon reading and understanding the specification, there is a need in the art for improved systems and methods for capacity management for a distributed antenna system.

### SUMMARY

The Embodiments of the present invention provide methods and systems for capacity management for a distributed antenna system and will be understood by reading and studying the following specification.

In one embodiment, a distributed antenna system comprises: a host unit; a plurality of remote antenna units coupled to the host unit via a plurality of communication links, wherein the plurality of communication links transport a radio frequency (RF) carrier signal between the host unit and at least one wireless subscriber unit via the plurality of remote units; and at least one capacity processor, wherein the capacity processor alters at least a portion of the RF carrier signal such that the at least one wireless subscriber unit can utilize a bandwidth of the RF carrier signal that is less than a full available bandwidth of the RF carrier signal.

In another embodiment, a distributed antenna system comprises: a host unit coupled to a base station; a plurality of remote antenna units coupled to the host unit via a plurality of communication links, wherein the plurality of communication links transport a radio frequency (RF) carrier signal between the host unit and at least one wireless subscriber unit via the plurality of remote units; and at least one capacity processor, wherein the capacity processor alters at least a portion of the RF carrier signal to attenuate the RF carrier signal to force the at least one wireless subscriber unit to use a first grade of service that is a different grade of service than a highest grade of service offered by the base station.

### DRAWINGS

Embodiments of the present invention can be more easily understood and further advantages and uses thereof more readily apparent, when considered in view of the description of the preferred embodiments and the following figures in which:

FIG. 1 is a block diagram illustrating a distributed antenna system of one embodiment of the present disclosure;

FIG. 2 is a diagram illustrating example implementations of a coverage filters of the present disclosure;

FIG. 3 is a diagram illustrating example implementations of a coverage filter of the present disclosure;

FIG. 4 is a flow chart illustrating a method of one embodiment of the present disclosure;

FIG. 5 is a diagram illustrating example implementations of a coverage filters of the present disclosure;

FIG. 6 is a flow chart illustrating a method of one embodiment of the present disclosure;

FIGS. 7A and 7B are diagrams illustrating time domain embodiment of the present disclosure;

FIG. 8A is a block diagram illustrating a remote antenna unit for distributed antenna system of one embodiment of the present disclosure; and

FIG. 8B is a block diagram illustrating a host unit for distributed antenna system of one embodiment of the present disclosure.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present disclosure provide for capacity distribution management within a distributed antenna system (DAS) by implementing a capacity processor at one or more remote antenna units (RAUs) of the DAS. These embodiments, as explained further below, do not require changes to underling communication protocols or allocation algorithms executed within cellular base stations. Instead, embodiments of the present disclosure intentionally alter portions of the RF signal to render subcarriers in those portions either unusable, or significantly limited in the data rates they can support. This RF signal is altered on a per RAU basis such that the RF signal processed by at one RAU would be altered differently than the RF signal processed at another RAU. Thus, while the DAS as a whole may process the entire spectrum of the RF signal, one or more individual branches of the DAS would be limited to a subset of that spectrum.

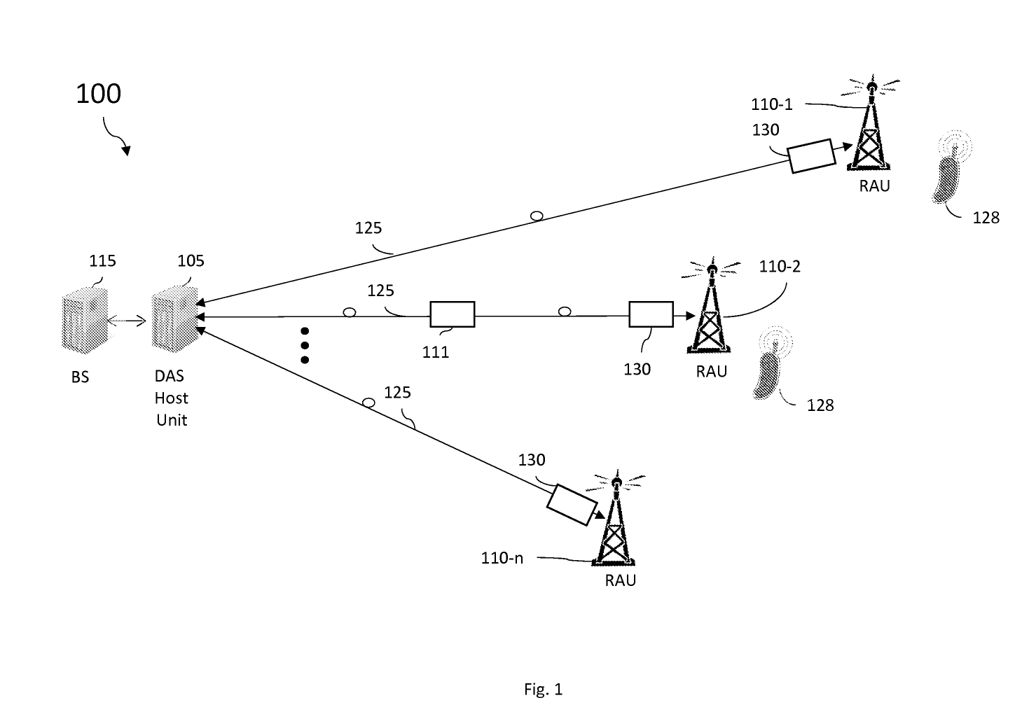

FIG. 1 is a block diagram illustrating a DAS 100, of one embodiment of the present disclosure. DAS 100 comprises a host unit 105 coupled to a plurality of remote antenna units (shown at 110-1 to 110-n). Remote antenna units may be directly coupled to a host unit, such as shown for remote antenna unit 110-1. Alternatively, in some implementations, one or more of the remote antenna units may be indirectly coupled to host unit 105, such as shown for remote antenna unit 110-2 where there is at least one intervening device 111 (which may comprise an intermediate or expansion unit, for example). In the downlink direction, DAS 100 operates as a point-to-multipoint transport for RF signals. That is, downlink RF carrier signals received by DAS 100 at host unit 105 from a base station (BS) 115 (which can be an RF source such as a cellular base station or base transceiver station (BTS), for example) are simultaneously transported to each of the remote antenna units 110-1 to 110-n. In the particular embodiment for FIG. 1, DAS 100 may be configured to operate as a digital DAS. For example, in one embodiment in operation, host unit 105 receives digitized RF signals from upstream sources which have been digitally up-converted and modulated in accordance with one or more over-the-air cellular modulation protocols. Each digitized RF signal carries packets of data samples of a modulated electromagnetic radio-frequency waveform. In one embodiment, each of the RAUs in DAS 100 receive the same stream of digitized RF signals and each produces a corresponding analog modulated RF waveform version of the digitized RF signals, and broadcast that waveform as an over-the-air RF signal. RAUs 110-1 to 110-n each include a digital-to-analog converter (DAC) and radiohead hardware, which perform the operations for producing the analog modulated RF waveform from digitized RF signals and amplifying the analog modulated RF waveform for broadcast as an over-the-air RF waveform to subscriber units 128. In the uplink direction, RF signals collected at each of the remote antenna units 110-1 to 110-n are transported to the host unit 105, where the RF signals are aggregated to provide a unified RE signal to further upstream components. In one embodiment, an RAU receives over-the-air RI communication signals from subscriber units within its service area and samples the analog RE communication signals to produce uplink digitized RF signals. The uplink digitized RF signals received from RAUs 110-1 to 110-n at host unit 105 are then mathematically combined to provide the unified stream of digitized RF signals to upstream components, such as BS 115. In other alternate embodiments, DAS 100 instead operates as a point-to-multipoint transport for digital baseband data (such as Common Public Radio Interface (CPRI) data, for example) or alternatively digitally transporting analog signals that are digitized by the DAS 100. Further, as mentioned below, in some capacity processor embodiments include implementations within an all analog DAS.

As shown in FIG. 1, host unit 105 is coupled to RAUs 110-1 to 110-n through bi-directional point-to-point communication links 125. In the particular embodiment shown in FIG. 1, communication links 125 are shown as fiber optic links. However, in other embodiments, other communications means such as but not limited to co-axial cables, CAT-5 cables, or microwave communication links may be utilized in various combinations.

With embodiments of the present invention, one or more of the RAUs 110-1 to 110-n further comprise a capacity processor 130 that tailors how much of the BS 115's capacity can be accessed through those RAUs by selectively altering parts of the RF carrier. In other words, within the RF carrier communicated between BS 115 and DAS 100, there is a finite quantity of bandwidth and/or throughput capacity available. The capacity processors described herein allow a system operator to decide how to divide that total capacity and to determine where that capacity is allocated within the context of a distributed antenna system. As explained below, the capacity processor alters at least a portion of the RF carrier signal such that wireless subscriber units whose communication flow through the capacity processor can utilize a limited bandwidth of the RF carrier signal that is less than the full available bandwidth of the RF carrier signal. This may also be accomplished by limiting throughput through time domain processing as discussed in greater detail below.

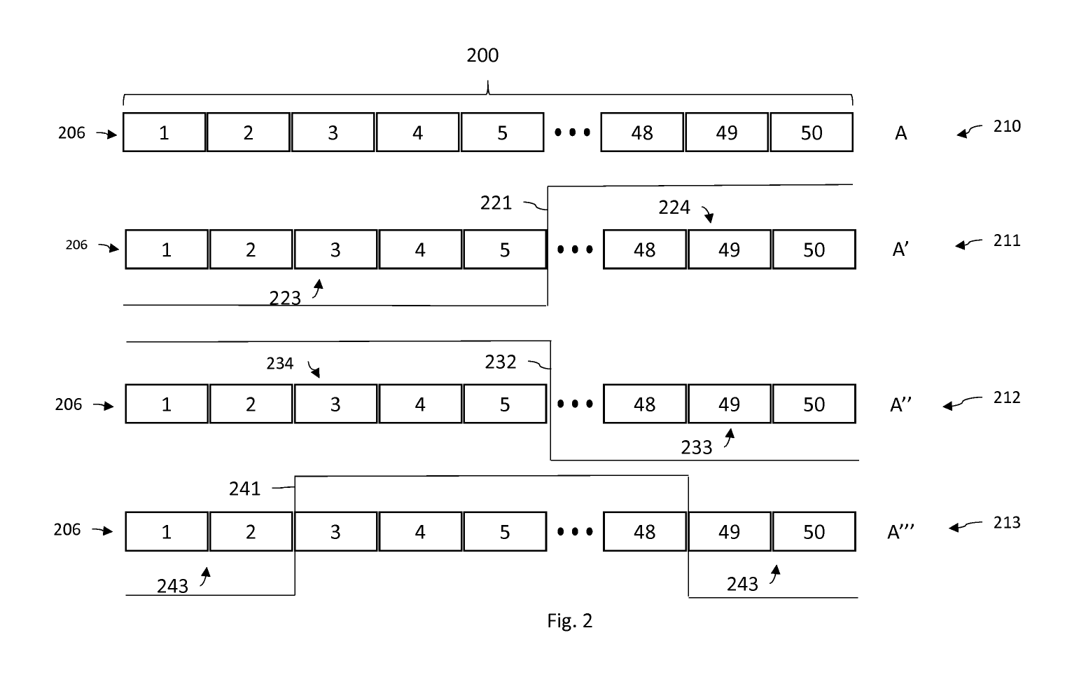

For example, in one embodiment, an RF carrier spectrum is divided into a plurality of resource blocks, each resource block further comprising a plurality of subcarriers. FIG. 2 illustrates one such embodiment where a 10 MHz RF carrier channel 200 is divided into 50 resource blocks (shown generally at 206). For this example embodiment, each of the resource blocks comprises 12 sub-carriers, with 15 kHz spacing. Accordingly, RF carrier channel 200 comprises a total of 600 sub-carriers within the 10 MHz total bandwidth of the channel. It should be appreciated that this example is not to be construed as limiting. In other embodiments, the RF channel may comprise a different total bandwidth divided into a different number of resource blocks each comprising a different number of sub-carriers. While in some embodiments, these resource blocks can comprise resource blocks as defined by Long Term Evolution (LTE) standards, other embodiments are not limited to resource blocks as defined by LTE standards.

In order to manage the fraction of BS 115's total capacity which may be accessed via an RAU (RAU 110-1, for example) the capacity processor 130 implemented at RAU 110-1 limits which resource blocks 206 are accessible and transported by RAU 110-1. For example, FIG. 2 at 210 illustrates a 10 MHz channel comprising a full 10 MHz spectrum of available sub-carriers (denoted as spectrum A). Spectrums A′, A″ and A′″ (shown at 211, 212 and 213 respectively) each illustrate how spectrum A can be filtered so that only a limited subset of the 600 sub-carriers available in spectrum A are accessible through RAU 110-1. This filtering is applicable to either uplink or downlink communications.

For example in spectrum A′ at 211, a capacity filter 221 implemented by capacity processor 130 for a first RAU blocks further transport of payload carrying sub-carriers in resource blocks 1-5 (as shown generally at 223). This leaves only resource blocks 6-50 available (as shown generally at 224) for the communication of data with wireless subscriber units, representing an approximate capacity reduction of 10%. In spectrum A″ at 212, the capacity filter 232 implemented by capacity processor 130 for a second RAU blocks further transport of payload carrying sub-carriers in resource blocks 6-50 (as shown generally at 233). This leaves only resource blocks 1-5 available (as shown generally at 234) for the communication of data with wireless subscriber unit, representing an approximate capacity reduction of 90%. Note that with some cellular communication protocols, such as LTE, certain subcarriers designated as control channels are allocated within the RF carrier channel. For example, in LTE, a 1.3 MHz control channel is often allocated at the center of a 10 MHz RF carrier channel. For such implementations, the applied capacity filter avoids filtering of those carrier channels. For example, in spectrum A′″ at 213, the capacity filter 241 is implemented by capacity processor 130 to block sub-carriers staring in from the edge of the 10 MHz channel in resource blocks 1-2 and 49-50 (shown at 243), passing payload carrying and control channel located towards the center of the spectrum.

For each of the spectrums A′, A″ and A′″, a wireless subscriber unit communicating through the respective RAU will have access to only a tailored fraction of sub-carriers that comprises less than the full spectrum of subcarriers otherwise available in the 10 MHz channel. The blocked subcarriers are otherwise valid payload carrying sub-carriers within the 10 MHz channel. Subscribers connected via RAU 110-1 simply are blocked from using them because of the capacity processor 130. By implementing such a capacity processor at one or more of the RAUs 110-1 to 110-n, a capacity profile for the entire DAS 100 may be tailored. For example, in one implementation within a building, a first RAU 110-1, which might be serving executive offices, may be tailored to provide more available capacity that a second RAU 110-2, which might be serving the building lobby. In another implementation, the capacity profile may be tailored such that only one RAU 110-1 has access to a grouping of resource blocks, essentially reserving at least some capacity exclusively for the use of subscribers accessing the system via that RAU.

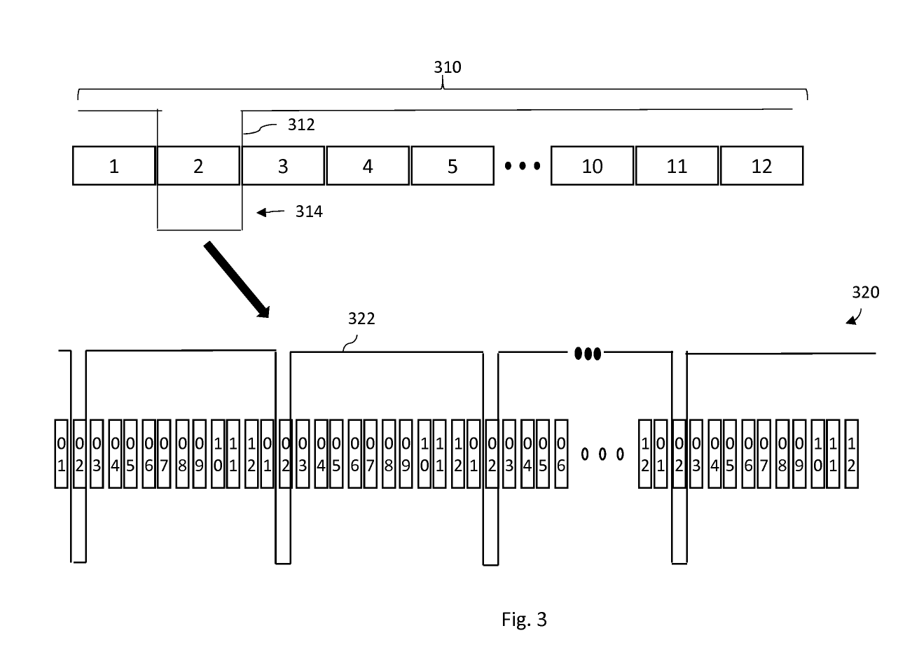

It should be appreciated that the subcarriers that define a resource block do not need to be a contiguous block of sub-carriers. For example, FIG. 3 at 310 illustrates a band of 12 resource blocks where a capacity filter 312 implemented by a capacity processor 130 blocks access to resource block 2 (shown at 314). As shown at 320, the sub-carriers that define recourse block 2 are actually spread across the band 310. In this example, resource block 2 is comprised of every twelfth sub-carrier in that band. Capacity filter 312 is therefore implemented as a comb filter (shown at 322) that blocks access to resource block 2. In still other embodiments the sub-carriers defining block 2 may be randomly distributed, and the capacity filter configured accordingly.

In one embodiment, in operation, the host unit 105 receives a downlink 10 MHz RF carrier signal from BS 115. The downlink 10 MHz RF carrier signal is a digitized signal, meaning that the signal comprises a stream of digital RF samples. Host unit 105 simulcasts the RF carrier signal to the plurality of RAUs 110-1 to 110-n. At least one of the RAUs implements a capacity processor 130 that filters out a fraction of the RF carrier's spectrum so that a mobile subscriber unit 128 in the service area of that RAU can only observe the portion of the RF carrier signal that is not blocked by the capacity processor 130. When BS 115 allocates resource blocks to a subscriber unit 128, it may not be immediately aware that the capacity processor is blocking part of the RF carrier spectrum. The mobile unit receives and analyzes the altered version of the RF carrier signal and identifies the blocked portion(s) of the waveform as having degraded quality sub-carriers. This quality assessment is transmitted back to the BS 115, which provides a downlink resource block allocation to the mobile unit that avoids the degraded quality sub-carriers. In one embodiment, upstream channel allocation works in much the same way. BS 115 assesses the uplink transmission from the mobile unit and identifies those sub-carriers being blocked by the capacity processor as degraded quality sub-carriers. BS 115 provides an uplink resource block allocation to the mobile unit that avoids the degraded quality sub-carriers.

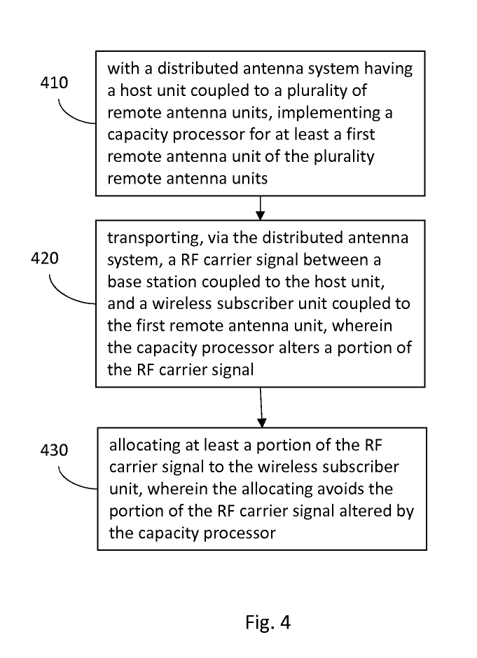

This process is further illustrated by the flow chart of FIG. 4. The process begins a 410 with a distributed antenna system having a host unit coupled to a plurality of remote antenna units, where a capacity processor is implemented for at least a first remote antenna unit of the plurality remote antenna units. The process proceeds to 420 with transporting, via the distributed antenna system, a RF carrier signal between a BS coupled to the host unit, and a subscriber unit coupled to the first remote antenna unit, wherein the capacity processor alters a portion of the RF carrier signal. The process proceeds to 430 with allocating at least a portion of the RF carrier signal to the wireless subscriber unit, wherein the allocating avoids the portion of the RF carrier signal altered by the capacity processor. For example, in one implementation within an LTE system, the base station is programmed to allocate sub-carriers that provide the best signal to interference ratio. The system evaluates the quality of sub-carriers in the link between the subscriber unit and the base station. The portions of the link blocked by the capacity processor are deemed unusable and are not allocated. For a second subscriber unit communicating via another RAU, that portion of the RF carrier signal is not block by a capacity processor. The base station is thus able to allocate sub-carriers through the second RAU that were blocked at the first RAU.

In another embodiment, rather than blocking specific sub-carriers, a capacity processor attenuates the RF carrier signal such that mobile subscriber units can only get high speed coverage a limited distance from the center of the coverage area. The capacity processor attenuates one or both of the uplink and downlink of the RF carrier at one or more RAUs to reduce the offered capacity within the coverage area of the RAUs. In some embodiments the downlink and uplink are attenuated by the same amount, or roughly the same amount, so as not to substantially affect open loop power control algorithms that assume the downlink and uplink have the same path loss between the infrastructure antenna and the subscriber unit. While attenuating the RF carrier does change the coverage area of the RAU, it actually changes the coverage area for different levels of service. That is, with no attenuation, the entire coverage area of the remote unit may achieve the highest data rate supported by the radio access technology. As higher amounts of attenuation are applied to the RF carrier, the amount of area with the highest data rate will be reduced but the outer edges of the coverage area will still get a lower level of throughput and at a minimum should have voice and/or texting capabilities. For example, for a subscriber unit to obtain a high data rate 64 MB/s connection, a relatively high signal to noise ratio is needed. As the subscriber unit gets farther from the RAU, the signal level drops, and the obtainable data rate drops accordingly.

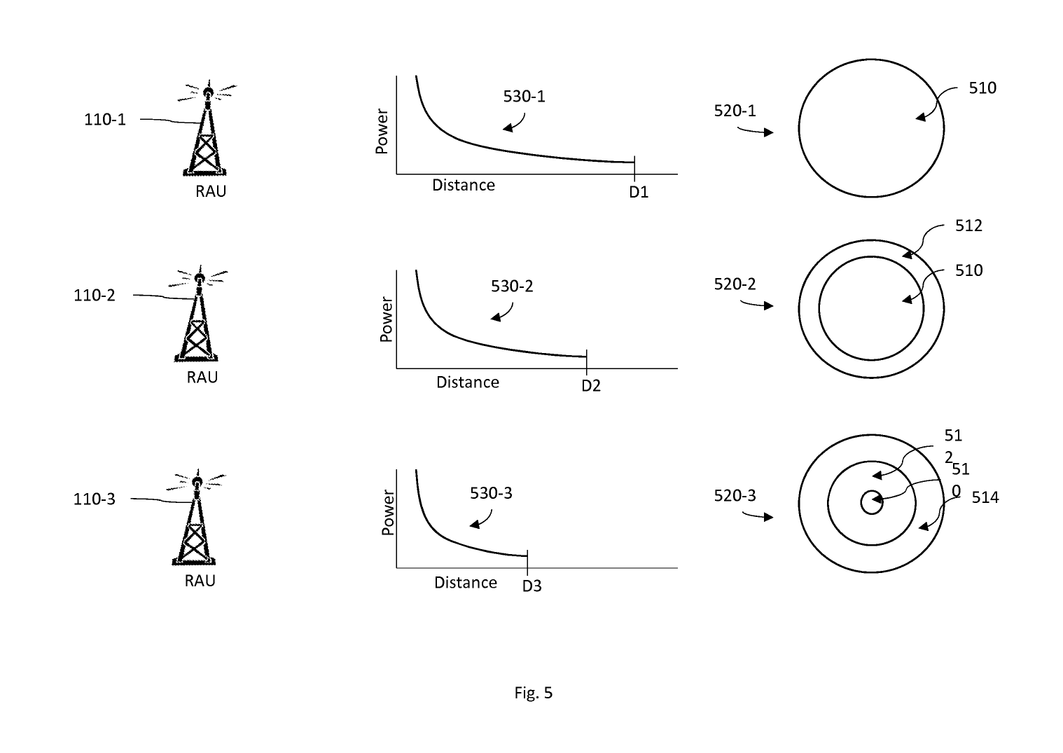

Referring to FIG. 5, coverage areas 520-1, 520-2 and 520-3 are shown for respective RAUs 110-1, 110-2 and 110-3. Referring first to RAU 110-1, the power versus distance curve shown at 530-1 illustrates that sufficient signal power to support high data rates can reach out to a distance of D1 from RAU 110-1. Since D1 meets or exceeds the radius for the full intended coverage area of RAU 110-1, the entirety of coverage area 520-1 comprises a first (high data rate) grade of service region 510. Referring next to RAU 110-2, the power versus distance curve shown at 530-2 illustrates that sufficient signal power to support high data rates can reach out to a more limited distance of D2 from RAU 110-2. In this case, attenuation of the RF signal at RAU 110-2 results in a coverage area 520-2 that comprises a smaller high data rate grade of service region 510 at its center, ringed by a second grade of service characterized by a relatively lower data rate region 512 that extends to the edge of coverage area 520-2.

Finally, referring to RAU 110-3, the power versus distance curve shown at 530-3 illustrates that sufficient signal power to support high data rates can reach out to a short distance of D3 from RAU 110-3. The attenuation of the RF signal at RAU 110-3 results in a coverage area 520-3 that comprises a very small high data rate region 510 at its center, ringed by a relatively low data rate region 512. Beyond low data rate region 512 there extends region 514 defining a third grade of service, in which there is only a sufficient signal-to-noise ratio to support voice, texting, and possibly low data rates. Thus given the finite bandwidth capacity of BS 115, it is clear to see from FIG. 5 that subscriber units within range of RAU 110-1 have significantly more access to that capacity than subscriber units within range of either RAU 110-2 or RAU 110-3. In one embodiment, in operation, channel allocation by BS 115 is based on the signal to noise ratio of the RF carrier at a subscriber unit when a connection is initiated. The signal to noise ratio determines the quality or grade of service available at the subscriber unit's location, and uplink and downlink subcarrier allocations are made based on that determined grade of service available.

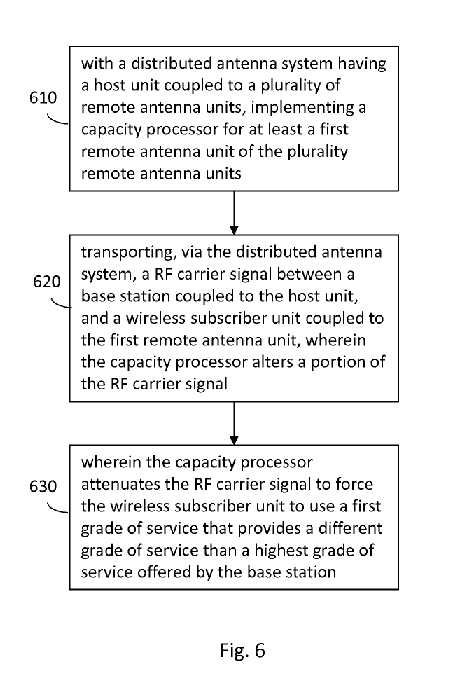

This process is further illustrated by the flow chart of FIG. 6. The process begins at 610 with a distributed antenna system having a host unit coupled to a plurality of remote antenna units, where a capacity processor is implemented for at least a first remote antenna unit of the plurality remote antenna units. The process proceeds to 620 with transporting, via the distributed antenna system, a RF carrier signal between a BS coupled to the host unit, and a subscriber unit coupled to the first remote antenna unit, wherein the capacity processor alters a portion of the RF carrier signal. The process proceeds to 630 wherein the capacity processor attenuates the RF carrier signal to force the wireless subscriber unit to use a first grade of service that provides a different grade of service than a highest grade of service offered by the base station. This first grade of service can also be different than a second grade of service that may be available through a second remote antenna unit of the plurality of antenna units.

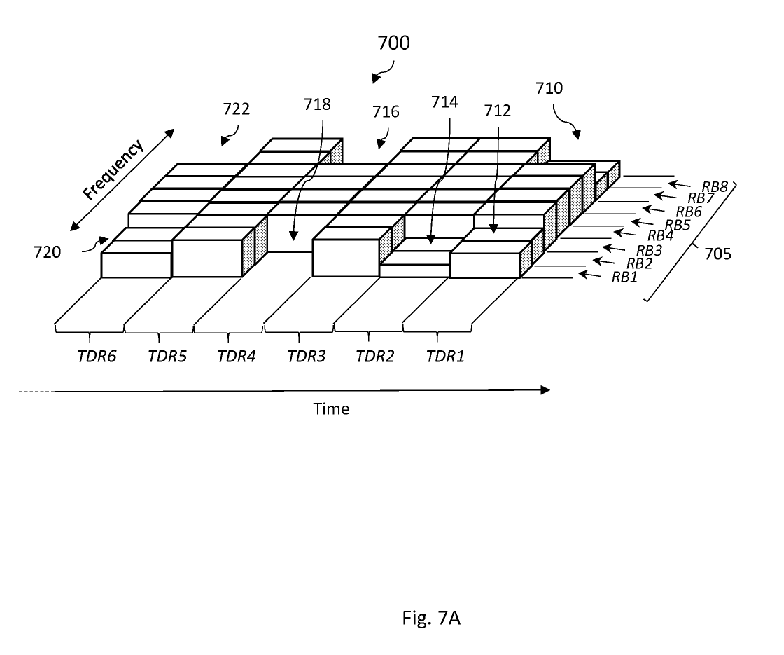

It should also be appreciated that embodiments present herein can be implemented in a time division manner such as where data transmissions via the RF carrier signal is partitioned into time resources (for example, such as timeslots in a time division duplex (TDD) system, or time division multiple access (TDMA) system). For example, FIG. 7A shows an RF carrier signal (shown generally at 700) having a frequency spectrum 705 divided into plurality of resource blocks (shown as RB1-RB8). RF carrier signal 700 is also divided into a plurality of divisions in time. These time division resource are shown in FIG. 7A as TDR1-6. In one embodiment, a capacity processor 130 can selectively alter the RF carrier signal 700 in specific time domain resources as well as spectral resource blocks in order to artificially limit capacity available to subscriber units 128 within the coverage area of the RAU associated with the capacity processor.

For example, in the embodiment illustrated in FIG. 7A, a capacity processor 130 associated with an RAU attenuates the RF carrier signal 700 to a first grade of service in resource blocks RB 1-2 (shown at 712) and attenuates the RF carrier signal 700 to a second grade of service in resource blocks RB7-8 (shown at 710), during the first time domain resource (TDR1). During the second time domain resource (TDR2), attenuation of resource blocks RB 1-2 is transitioned to a second grade of service (shown at 714) while alteration of resource blocks RB7-8 is discontinued. For the third time domain resource (TDR3), capacity filter 130 does not apply any alteration to any of RB1-8. Then during the time division for TDR4, capacity filter 130 implements a capacity filter that block RB1-2 and RB7-8. For the next time domain resource (TDR5), capacity filter 130 again does not apply an alteration to any of RB 1-8. Then for the sixth time domain resource (TDR6), capacity filter 130 alters the RF carrier signal 700 to attenuate resource blocks RB1-2 to a first grade of service (shown at 720) and implements a capacity filter that blocks RB7-8 (shown at 722). Thus as shown by FIG. 7A, resource block capacity filtering and signal attenuation embodiments may be combined and simultaneously performed by a capacity processor, and still further combined with time domain processing as shown in FIG. 7A.

FIG. 7B illustrates another embodiment where an RF carrier signal 750 having a frequency spectrum 755 is partitioned into time domain resources TDR1-6, but the alterations implemented by capacity processor 130 are uniformly applied across the frequency spectrum 755, regardless of whether or not the frequency spectrum 755 is further divided into resource blocks. For example, FIG. 7B may illustrate application of the above embodiments to a single frequency data transmission or a Global System for Mobile Communications (GSM) system. As illustrated in FIG. 7B, a capacity filter 130 can alter signal 750 across spectrum 755 during time domain resources TDR1, TDR2 and TDR4, without altering signal 750 during time domain resources TDR3, TDR5 and TDR6. More specifically, in this example capacity processor 130 attenuates the RF carrier signal 750 to a first grade of service (shown at 760) during TDR1, and to a second grade of service (shown at 762) during TDR2. Thus for a subscriber unit allocated TDR1, they would be able to communicate with the RAU at a data rate that is a function of the attenuated signal power available to the subscriber unit at its distance from the RAU. For a second subscriber unit allocated TDR2, they would be able to communicate with the RAU at a data rate that is also a function of the attenuated signal power, but that may be a different data rate than available to the first subscriber unit (even if they are at an equivalent distance from the RAU). In the example of FIG. 7B, capacity processor 130 also implements a capacity filter during TDR4 that blocks the RF carrier signal 750 during that time period. Therefore TDR4 would not be a resource available for any subscriber unit in the service region of the RAU associated with that capacity processor.

Any of the capacity processors described above may be implemented as a digital filter. Therefore, in some embodiments, the capacity profile of a DAS may be reconfigured remotely by replacing the filter coefficients of the digital filter at one or more remote antenna units. For example, to reconfigure the capacity processor 130 of RAU 110-1, in one embodiment a control message addressed to RAU 110-1 is transmitted by host unit 105. RAU 110-1 recognizes that the control message contains new filter coefficients for its capacity processor 130 and loads them. The new filter coefficients may take effect immediately upon loading, or alternatively, take effect upon a reset of RAU 110-1. In other embodiments, the capacity processor may be programmed to automatically switch between sets of filters, such as on a time of day basis, before and after a planned event, or other basis. For example, a DAS installed at a sports complex may be programmed to provide a first capacity profile during non-game days, and reallocate capacity on days where events are planned. Alternatively, in some embodiments, fixed filters (either analog or digital) may be used that are configured to be field replaceable.

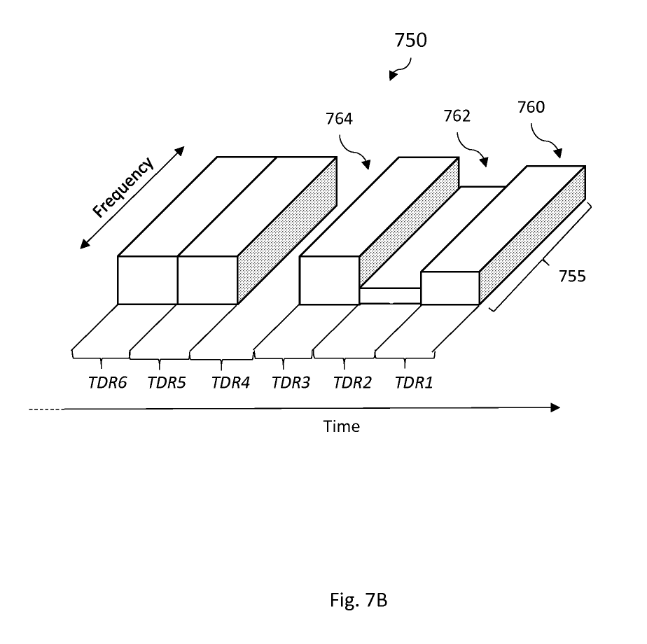

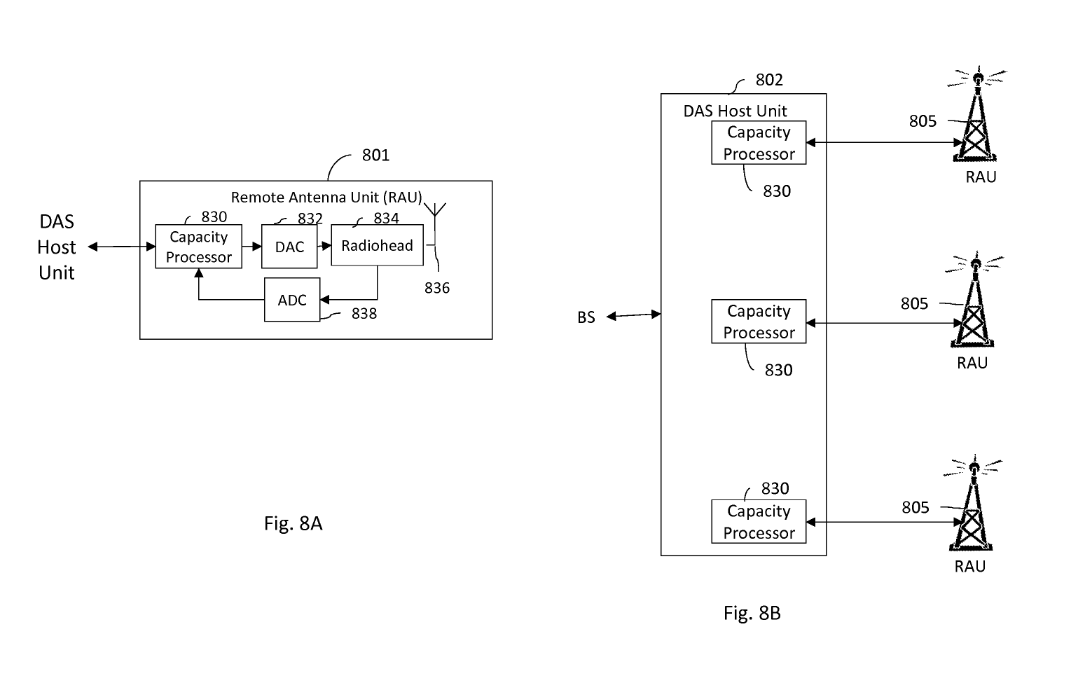

Also, as illustrated in FIGS. 8A and 8B, the various embodiments of a capacity processor described above can be physically implemented either within a remote antenna unit, or within the host unit. For example, FIG. 8A illustrates a remote antenna unit 801 for implementing a digital distributed antenna system. RAU 801 comprising a capacity processor 830, a digital-to-analog converter (DAC) 832, an analog-to-digital converter (ADC) 838, a radiohead 834 and an antenna 836. In the downlink directions, the RF carrier signal as transported by a stream of downlink digital RF packets is received from the DAS host unit at RAU 801. The capacity processor 830 performs filtering as described in any of the above embodiments to alter the RF carrier signal such that wireless subscriber unit units whose communication flow through the capacity processor can utilize a bandwidth of the RF carrier signal that is less than a full available bandwidth of the RF carrier signal. The digital RF packets are converted to an analog signal by DAC 832 and amplified Band broadcast as a wireless signal by radiohead 834 via antenna 836. Radiohead 834 may also perform filtering and gain control functions as needed. In the uplink direction, an RF carrier signal is received as an analog signal by radiohead 834 via antenna 836. The analog signal is converted into a stream of uplink digital RF packets by ADC 838. The capacity processor 830 performs its filtering as described in any of the above embodiments to the uplink digital RF packets before they are transmitted to the DAS host unit for aggregating with uplink digital RF packets from other RAUs. FIG. 8B shows an alternate implementation, where a DAS host unit 802 comprises one or more capacity processors 830 that are coupled to RAUs 805. The implementation of FIG. 8B functions in operation identically as described with respect to FIG. 8A, the difference being that the capacity processors 830 that operate in conjunction with the RAUs 805 are physically located upstream within the DAS host unit 802 hardware.

In some embodiments, adjustment of the capacity profile for a DAS may be tailored dynamically based on real time measurements of traffic loading. For example, in one embodiment, the traffic load through a particular RAU can be estimated. As explained in the various embodiments above, an RAU has associated with it a capacity processor that selectively alters the RF carrier so that only a subset of the RF carrier's total bandwidth is accessible via that RAU. Therefore, in some embodiments, if the traffic load estimate indicates that an RAU is approaching high or full utilization of that subset of the RF carrier, then the capacity processor may be reconfigured to lessen its alteration of the RF carrier, thus opening up more of the RF carrier for utilization by that RAU.

In one embodiment, DAS 100 periodically or continuously monitors traffic loading at each RAU 110-1 to 110-n to identify those having high and low utilization. In some embodiments, the RAUs may be ranked based on a percent utilization factor. Using this information, when the capacity processor at one RAU is reconfigured to open up more access to the RF carrier bandwidth, the capacity processor for a second RAU (identified as having low utilization) can alter the RF carrier at the second RAU to further reduce its ability to access the RF carrier bandwidth.

In some embodiments, RF signal power is measured at each RAU in order to obtain an estimate of traffic loading at that RAU. That is, measuring the local RF signal power at an RAU (within the frequency spectrums being utilized by the DAS) may serve as a proxy for estimating the total traffic load flowing through that RAU. Similarly, for protocols that assign to subscribers time and frequency defined resource blocks (such as LTE, for example) monitoring the local RF signal power within time and frequency resources can provide an indication of the activity level within the resource blocks currently in use at that RAU, which can then be translated into a traffic loading estimate.

The traffic monitoring process can be cooperative in nature where the information provided from each RAU is processed collectively to determine an optimal traffic capacity configuration of the RAUs from an overall network perspective, or the traffic monitoring process can be performed independently at each RAU with some level of autonomy for each RAU. In some embodiments, the raw measurement data collected at the RAUs 110-1 to 110-n is communicated back to the DAS host 105 and from this raw data the DAS host unit 105 calculates traffic loading estimates and coordinates reconfiguration of the capacity processor to accommodate the changes in traffic loads. In other embodiments, the RAU 110-1 to 110-n collects raw measurements, calculates the traffic loading estimate itself, and reports the traffic loading estimates back to the DAS host unit 105 so that the DAS host unit 105 may coordinate reconfiguration of the capacity processor to accommodate the changes in traffic loads. In still other embodiments, an RAU 110-1 to 110-n may calculate a traffic loading estimate, but as opposed to sending that estimate to the DAS host unit 105, the RAU may instead translate that estimate into a specific request for more bandwidth which is then processed by the DAS host unit 105. The DAS host unit 105 could then adjust the capacity profile for the DAS accordingly by reconfiguring one or more of the capacity processors as described above. The capacity processor for an RAU may also be provided limited autonomy, in some embodiments, to reconfigure itself without first coordinating with the rest of the DAS, for example to provide a limited increase in capacity for a limited time duration. Further, upper and lower capacity levels may be established for each RAU. For example, in one embodiment, an RAU within DAS 100 may have a capacity processor configured to always maintain, regardless of traffic loading conditions at least a minimum access to the RF carrier bandwidth. Conversely, the capacity process for another RAU within DAS 100 may be configured such that it is always limited to access no more than a predetermined portion of the RF carrier.

### Example Embodiments

Example 1 includes a distributed antenna system, the antenna system comprising: a host unit; a plurality of remote antenna units coupled to the host unit via a plurality of communication links, wherein the plurality of communication links transport a radio frequency (RF) carrier signal between the host unit and at least one wireless subscriber unit via the plurality of remote units; and at least one capacity processor, wherein the capacity processor alters at least a portion of the RF carrier signal such that the at least one wireless subscriber unit can utilize a bandwidth of the RF carrier signal that is less than a full available bandwidth of the RF carrier signal.

Example 2 includes the system of example 1, further comprising a first remote antenna unit of the plurality of antenna units; wherein the at least one capacity processor comprises a first capacity processor that alters the at least a portion of the RF carrier signal transported by the first remote antenna unit.

Example 3 includes the system of example 2, wherein the first capacity processor is implemented within the first remote antenna unit.

Example 4 includes the system of examples 2 or 3, further comprising a second remote antenna unit of the plurality of antenna units, wherein a second capacity processor alters a second a portion of the RF carrier signal as transported by the second remote antenna unit.

Example 5 includes the system of example 4, wherein the second capacity processor is implemented within the second remote antenna unit.

Example 6 includes the system of examples 4, wherein the second capacity processor is implemented at the host unit.

Example 7 includes the system of example 1, wherein the first capacity processor is implemented at the host unit.

Example 8 includes the system of any of examples 1-7, wherein the at least one capacity processor filters out one or more resource blocks or sub-carriers from the RF carrier signal.

Example 9 includes the system of any of examples 1-8, wherein the at least one capacity processor does not filter out control channels from the RF carrier signal.

Example 10 includes the system of any of examples 1-9, further comprising a first remote antenna unit of the plurality of antenna unit; wherein the at least one capacity processor attenuates the RF carrier signal to force the at least one wireless subscriber unit to use a second grade of service that is a different grade of service than a first grade of service available through a second remote antenna unit of the plurality of antenna units.

Example 11 includes the system of any of examples 1-9, further comprising a first remote antenna unit of the plurality of antenna unit; wherein the at least one capacity processor attenuates the RF carrier signal to force the at least one wireless subscriber unit to use a grade of service that is a different grade of service than a highest grade of service offered by a base station coupled to the host unit.

Example 12 includes the system of any of examples 1-11, wherein the at least one capacity processor is implemented differently for uplink verses downlink communications.

Example 13 includes the system of any of examples 1-12, wherein the radio frequency (RF) carrier signal is transmitted within the digital antenna system by a digital transport, where the RF carrier signal comprises a stream of digital RF packets, wherein each digital RF packet carries data samples of a the RF carrier signal.

Example 14 includes the system of any of examples 1-13, wherein the at least one capacity processor is implemented as a digital filter.

Example 15 includes the system of any of examples 1-14, wherein the at least one capacity processor is implemented as a remotely reconfigurable filter.

Example 16 includes the system of any of examples 1-15, wherein the at least one capacity processor alters the at least a portion of the RF carrier signal during a first time division resource within the RF carrier signal differently than during a second time division resource within the RF carrier signal

Example 17 includes a distributed antenna system comprising: a host unit coupled to a base station; a plurality of remote antenna units coupled to the host unit via a plurality of communication links, wherein the plurality of communication links transport a radio frequency (RF) carrier signal between the host unit and at least one wireless subscriber unit via the plurality of remote units; and at least one capacity processor, wherein the capacity processor alters at least a portion of the RF carrier signal to attenuate the RF carrier signal to force the at least one wireless subscriber unit to use a first grade of service that is a different grade of service than a highest grade of service offered by the base station.

Example 18 includes the system of example 17 further comprising a first remote antenna unit of the plurality of antenna unit; wherein the first grade of service is a different grade of service than a second grade of service available through a second remote antenna unit of the plurality of antenna units.

Example 19 includes the system of example 18 wherein the first capacity processor is implemented within the first remote antenna unit.

Example 20 includes the system of example 18 wherein the first capacity processor is implemented at the host unit.

Example 21 includes the system of any of examples 17-20 wherein the at least one capacity processor is implemented differently for uplink verses downlink communications.

Example 22 includes the system of any of examples 17-21 wherein the radio frequency (RF) carrier signal is transmitted within the digital antenna system by a digital transport, where the RF carrier signal comprises a stream of digital RF packets, wherein each digital RF packet carries data samples of a the RF carrier signal.

Example 23 includes the system of any of examples 17-22, wherein the at least one capacity processor is implemented as a digital filter.

Example 24 includes the system of any of examples 17-23, wherein the at least one capacity processor is implemented as a remotely reconfigurable filter.

Example 25 includes the system of any of examples 17-24, wherein the at least one capacity processor alters the at least a portion of the RF carrier signal during a first time division resource within the RF carrier signal differently than during a second time division resource within the RF carrier signal

Example 26 includes a method for managing capacity distribution within a distributed antennal system, the distributed antennal system comprising a host unit coupled to a plurality of remote antenna units, the method comprising: implementing a capacity processor for at least a first remote antenna unit of the plurality of antenna units; transporting, via the distributed antenna system, a radio-frequency (RF) carrier signal between a base station coupled to the host unit, and a wireless subscriber unit coupled to the first remote antenna unit, wherein the capacity processor alters a portion of the RF carrier signal; and allocating at least a portion of the RF carrier signal to the wireless subscriber unit, wherein the allocating avoids the portion of the RF carrier signal altered by the capacity processor.

Example 27 includes the method of example 26, wherein the capacity processor is implemented within the first remote antenna unit.

Example 28 includes the method of any of examples 25-27, the distributed antenna system further comprising a second remote antenna unit of the plurality of antenna units, the method further comprising: implementing a second capacity processor alters a second a portion of the RF carrier signal as transported by the second remote antenna unit.

Example 29 includes the method of example 28, wherein the second capacity processor is implemented within the second remote antenna unit.

Example 30 includes the method of example 28, wherein the second capacity processor is implemented within the host unit.

Example 31 includes the method of any of examples 26 or 28-30, wherein the capacity processor is implemented within the host unit.

Example 32 includes the method of any of examples 26-31, wherein the capacity processor filters out one or more resource blocks or sub-carriers from the RF carrier signal.

Example 33 includes the method of any of examples 26-32, wherein the radio frequency (RF) carrier signal is transmitted within the digital antenna system by a digital transport, where the RF carrier signal comprises a stream of digital RF packets, wherein each digital RF packet carries data samples of a the RF carrier signal.

Example 34 includes the method of any of examples 26-33, wherein the capacity processor alters the at least a portion of the RF carrier signal during a first time division resource within the RF carrier signal differently than during a second time division resource within the RF carrier signal.

Example 35 includes a method for managing capacity distribution within a distributed antennal system, the distributed antennal system comprising a host unit coupled to a plurality of remote antenna units, the method comprising: implementing a capacity processor for at least a first remote antenna unit of the plurality of antenna units; and transporting, via the distributed antenna system, a radio-frequency (RF) carrier signal between a base station coupled to the host unit, and a wireless subscriber unit coupled to the first remote antenna unit, wherein the capacity processor alters a portion of the RF carrier signal; and wherein the capacity processor attenuates the RF carrier signal to force the wireless subscriber unit to use a first grade of service that provides a different grade of service than a highest grade of service offered by the base station.

Example 36 includes the method of example 35, wherein the first grade of service is different than a second grade of service available through a second remote antenna unit of the plurality of antenna units.

Example 37 includes the method of examples 35 or 36, wherein the capacity processor is implemented within the first remote antenna unit.

Example 38 includes the method of examples 35 or 36, wherein the capacity processor is implemented within the host unit.

Example 39 includes the method of any of examples 35-38, the distributed antenna system further comprising a second remote antenna unit of the plurality of antenna units, the method further comprising: implementing a second capacity processor alters a second a portion of the RF carrier signal as transported by the second remote antenna unit.

Example 40 includes the method of any of examples 35-39, wherein the radio frequency (RF) carrier signal is transmitted within the digital antenna system by a digital transport, where the RF carrier signal comprises a stream of digital RF packets, wherein each digital RF packet carries data samples of a the RF carrier signal.

Example 41 includes the method of any of examples 35-40, wherein the capacity processor alters the at least a portion of the RF carrier signal during a first time division resource within the RF carrier signal differently than during a second time division resource within the RF carrier signal.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A distributed antenna system, the antenna system comprising:
a host unit;
a plurality of remote antenna units coupled to the host unit via a plurality of communication links, wherein the plurality of communication links transport a radio frequency (RF) carrier signal between the host unit and at least one wireless subscriber unit via the plurality of remote units; and
at least one capacity processor, wherein the capacity processor alters at least a portion of the RF carrier signal such that the at least one wireless subscriber unit can utilize a bandwidth of the RF carrier signal that is less than a full available bandwidth of the RF carrier signal.

2. The system of claim 1, further comprising a first remote antenna unit of the plurality of antenna units;
wherein the at least one capacity processor comprises a first capacity processor that alters the at least a portion of the RF carrier signal transported by the first remote antenna unit.

3. The system of claim 2, wherein the first capacity processor is implemented within the first remote antenna unit.

4. The system of claim 2, further comprising a second remote antenna unit of the plurality of antenna units, wherein a second capacity processor alters a second a portion of the RF carrier signal as transported by the second remote antenna unit.

5. The system of claim 4, wherein the second capacity processor is implemented within the second remote antenna unit.

6. The system of claim 4, wherein the second capacity processor is implemented at the host unit.

7. The system of claim 2, wherein the first capacity processor is implemented at the host unit.

8. The system of claim 1, wherein the at least one capacity processor filters out one or more resource blocks or sub-carriers from the RF carrier signal.

9. The system of claim 1, wherein the at least one capacity processor does not filter out control channels from the RF carrier signal.

10. The system of claim 1, further comprising a first remote antenna unit of the plurality of antenna unit;
wherein the at least one capacity processor attenuates the RF carrier signal to force the at least one wireless subscriber unit to use a second grade of service that is a different grade of service than a first grade of service available through a second remote antenna unit of the plurality of antenna units.

11. The system of claim 1, further comprising a first remote antenna unit of the plurality of antenna unit;
wherein the at least one capacity processor attenuates the RF carrier signal to force the at least one wireless subscriber unit to use a grade of service that is a different grade of service than a highest grade of service offered by a base station coupled to the host unit.

12. The system of claim 1, wherein the at least one capacity processor is implemented differently for uplink verses downlink communications.

13. The system of claim 1, wherein the radio frequency (RF) carrier signal is transmitted within the digital antenna system by a digital transport, where the RF carrier signal comprises a stream of digital RF packets, wherein each digital RF packet carries data samples of a the RF carrier signal.

14. The system of claim 1, wherein the at least one capacity processor is implemented as a digital filter.

15. The system of claim 1, wherein the at least one capacity processor is implemented as a remotely reconfigurable filter.

16. The system of claim 1, wherein the at least one capacity processor alters the at least a portion of the RF carrier signal during a first time division resource within the RF carrier signal differently than during a second time division resource within the RF carrier signal

17. A distributed antenna system, the antenna system comprising:
a host unit coupled to a base station;
a plurality of remote antenna units coupled to the host unit via a plurality of communication links, wherein the plurality of communication links transport a radio frequency (RF) carrier signal between the host unit and at least one wireless subscriber unit via the plurality of remote units; and
at least one capacity processor, wherein the capacity processor alters at least a portion of the RF carrier signal to attenuate the RF carrier signal to force the at least one wireless subscriber unit to use a first grade of service that is a different grade of service than a highest grade of service offered by the base station.

18. The system of claim 17, further comprising a first remote antenna unit of the plurality of antenna unit;
wherein the first grade of service is a different grade of service than a second grade of service available through a second remote antenna unit of the plurality of antenna units.

19. The system of claim 18, wherein the first capacity processor is implemented within the first remote antenna unit.

20. The system of claim 18, wherein the first capacity processor is implemented at the host unit.

21. The system of claim 17, wherein the at least one capacity processor is implemented differently for uplink verses downlink communications.

22. The system of claim 17, wherein the radio frequency (RF) carrier signal is transmitted within the digital antenna system by a digital transport, where the RF carrier signal comprises a stream of digital RF packets, wherein each digital RF packet carries data samples of a the RF carrier signal.

23. The system of claim 17, wherein the at least one capacity processor is implemented as a digital filter.

24. The system of claim 17, wherein the at least one capacity processor is implemented as a remotely reconfigurable filter.

25. The system of claim 17, wherein the at least one capacity processor alters the at least a portion of the RF carrier signal during a first time division resource within the RF carrier signal differently than during a second time division resource within the RF carrier signal

26. A method for managing capacity distribution within a distributed antennal system, the distributed antennal system comprising a host unit coupled to a plurality of remote antenna units, the method comprising:
implementing a capacity processor for at least a first remote antenna unit of the plurality of antenna units;
transporting, via the distributed antenna system, a radio-frequency (RF) carrier signal between a base station coupled to the host unit, and a wireless subscriber unit coupled to the first remote antenna unit, wherein the capacity processor alters a portion of the RF carrier signal; and
allocating at least a portion of the RF carrier signal to the wireless subscriber unit, wherein the allocating avoids the portion of the RF carrier signal altered by the capacity processor.

27. The method of claim 26, wherein the capacity processor is implemented within the first remote antenna unit.

28. The method of claim 26, the distributed antenna system further comprising a second remote antenna unit of the plurality of antenna units, the method further comprising:
implementing a second capacity processor alters a second a portion of the RF carrier signal as transported by the second remote antenna unit.

29. The method of claim 28, wherein the second capacity processor is implemented within the second remote antenna unit.

30. The method of claim 28, wherein the second capacity processor is implemented within the host unit.

31. The method of claim 26, wherein the capacity processor is implemented within the host unit.

32. The method of claim 26, wherein the capacity processor filters out one or more resource blocks or sub-carriers from the RF carrier signal.

33. The method of claim 26, wherein the radio frequency (RF) carrier signal is transmitted within the digital antenna system by a digital transport, where the RF carrier signal comprises a stream of digital RF packets, wherein each digital RF packet carries data samples of a the RF carrier signal.

34. The method of claim 26, wherein the capacity processor alters the at least a portion of the RF carrier signal during a first time division resource within the RF carrier signal differently than during a second time division resource within the RF carrier signal.

35. A method for managing capacity distribution within a distributed antennal system, the distributed antennal system comprising a host unit coupled to a plurality of remote antenna units, the method comprising:
implementing a capacity processor for at least a first remote antenna unit of the plurality of antenna units;
transporting, via the distributed antenna system, a radio-frequency (RF) carrier signal between a base station coupled to the host unit, and a wireless subscriber unit coupled to the first remote antenna unit, wherein the capacity processor alters a portion of the RF carrier signal; and
wherein the capacity processor attenuates the RF carrier signal to force the wireless subscriber unit to use a first grade of service that provides a different grade of service than a highest grade of service offered by the base station.

36. The method of claim 35, wherein the first grade of service is different than a second grade of service available through a second remote antenna unit of the plurality of antenna units.

37. The method of claim 35, wherein the capacity processor is implemented within the first remote antenna unit.

38. The method of claim 35, wherein the capacity processor is implemented within the host unit.

39. The method of claim 35, the distributed antenna system further comprising a second remote antenna unit of the plurality of antenna units, the method further comprising:
implementing a second capacity processor alters a second a portion of the RF carrier signal as transported by the second remote antenna unit.

40. The method of claim 35, wherein the radio frequency (RF) carrier signal is transmitted within the digital antenna system by a digital transport, where the RF carrier signal comprises a stream of digital RF packets, wherein each digital RF packet carries data samples of a the RF carrier signal.

41. The method of claim 35, wherein the capacity processor alters the at least a portion of the RF carrier signal during a first time division resource within the RF carrier signal differently than during a second time division resource within the RF carrier signal.
